(19) United States
(12) Patent Application Publication
(10) Pub. No.: US 2008/0009777 A1
(43) Pub. Date: Jan. 10, 2008

(54) Massage chair mechanism

(76) Inventor: Yu-Mei Chiu, Taoyuan Hsien (TW)

Correspondence Address: BACON & THOMAS, PLLC, 625 SLATERS LANE, FOURTH FLOOR, ALEXANDRIA, VA, 22314, US

(21) Appl. No.: 11/480,976

(22) Filed: Jul. 6, 2006

(51) Int. Cl. A61H 7/00

(52) U.S. Cl. 601/99; 601/98; 601/101; 601/103

(57) ABSTRACT

A massage chair mechanism is provided with a backrest comprising a main body plate. A left supporting plate of the main body plate is provided with an inclining device. With the help of a detecting device and a rotation-measuring element on the inclining device, the signals from the person to be massaged are transmitted to a main control board. The main control board issues a command to drive a crank device to rotate. The rotation of the crank device can drive big and small massaging balls of the massage device to move forwardly and backwardly, such that the most comfortable massage can be applied to the person to be massaged. A footrest elevation device and a calf-rest extension device are provided, thereby moving the footrest to an appropriate location.

### BACKGROUND OF THE INVENTION

1. Field of the Invention

The present invention relates generally to a massaging mechanism, and more particularly to a massage chair mechanism, in which the massage is carried out by rotating a massaging mechanism to adjust big and small massaging balls conforming to body's curves and by moving a footrest to desired location for a foot and calf massage.

2. The Prior Arts

A massage chair is one of health equipments widely used to massage the human body. Since the massage area covered by the massage chair is widespread and the massage program functions are variable, many people enjoy using the massage chair. However, the design of the massage chair influences the massage effect a lot. If the massage chair is well designed, it helps dissolve away tension and muscle stiffness from the person to be massaged. On the contrary, with improper massage, the result may be another trauma to the body. Therefore, all the massage chair manufacturers devote themselves to a better design to achieve perfect massage effect.

Examining the existing massage chair mechanisms available in the market, the massaging balls are slightly extruded along the backrest. When in use, the massaging balls of the massaging mechanism cannot reach the tops of the shoulders of the person to be massaged. Further, the massaging pressure of the massaging balls cannot be adjusted when they move upward and downward along the backrest. Also, if the person to be massaged lies back and hits the massaging balls violently, the massaging balls cannot automatically retract to relieve the tapping pressure. Therefore, it is an important issue to improve the massaging mechanism to satisfy the demands of the person to be massaged.

### SUMMARY OF THE INVENTION

In order to overcome the disadvantages of the prior art, a primary objective of the present invention is to provide a massaging mechanism for a massage chair, wherein an inclining mechanism is included. The inclining mechanism is provided with a detecting device and a rotation-measuring element to respond to the feedback signals from the person to be massaged. With the inclining device driving a crank device to rotate, the big and small massaging balls of the massage device can rotate to the tops of the shoulders of the person to be massaged to carry out the massage.

Another objective of the present invention is to provide a massage chair mechanism, wherein a detecting device and a rotation-measuring element are included. With the detecting device and the rotation-measuring element responding to the feedback signals from the person to be massaged, the inclining device can drive a crank to rotate the big and small massaging balls to adjust their reaching out distance, such that the massaging pressure of the big and small massaging balls applied to the user can be properly adjusted.

Another objective of the present invention is to provide a massage chair mechanism, wherein the big and small massaging balls of the massage device can retract automatically by compressing a spring of a universal rotating device. The knocking pressure applied on the person to be massaged by the massaging balls can be relieved. As a result, it will not hurt the user.

Another objective of the present invention is to provide a massage chair mechanism, wherein a footrest elevation device and a calf-rest extension device can move the footrest manually or automatically to an appropriate location.

### BRIEF DESCRIPTION OF THE DRAWINGS

FIG. 1 is a side view of a massage chair means according to the present invention;

FIG. 2 is a rear view of the massage chair means of the present invention;

FIG. 3 is a view showing a crank device and a universal rotating device;

FIG. 4 is a view of a knocking device;

FIG. 5 is a view of a kneading device;

FIG. 6 is a view of an inclining device;

FIG. 7 is a view of a detecting device;

FIGS. 8(a)-8(d) are views of manual footrest elevation device; and

FIGS. 9(a)-9(d) are views of automatic calf-rest extension device.

### DETAILED DESCRIPTION OF THE PREFERRED EMBODIMENT

In order to make the Examiner further understand the structure, characteristics and effects of the present invention, a detailed description of a preferred embodiment thereof will be made with reference to the accompanying drawings.

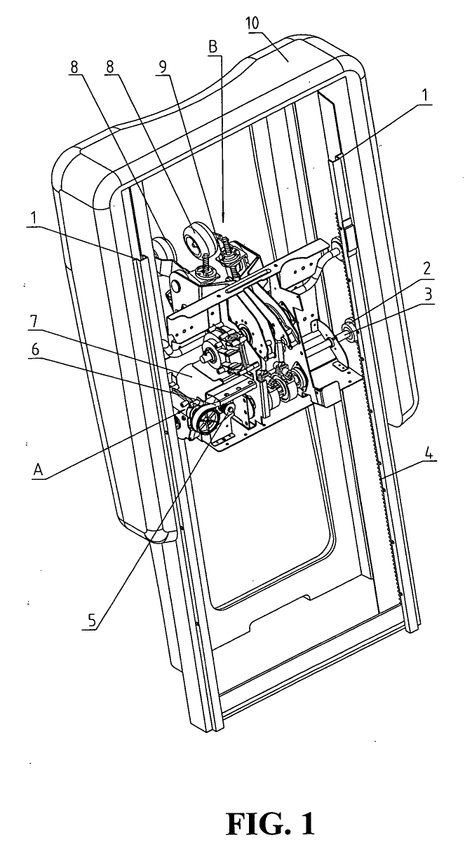

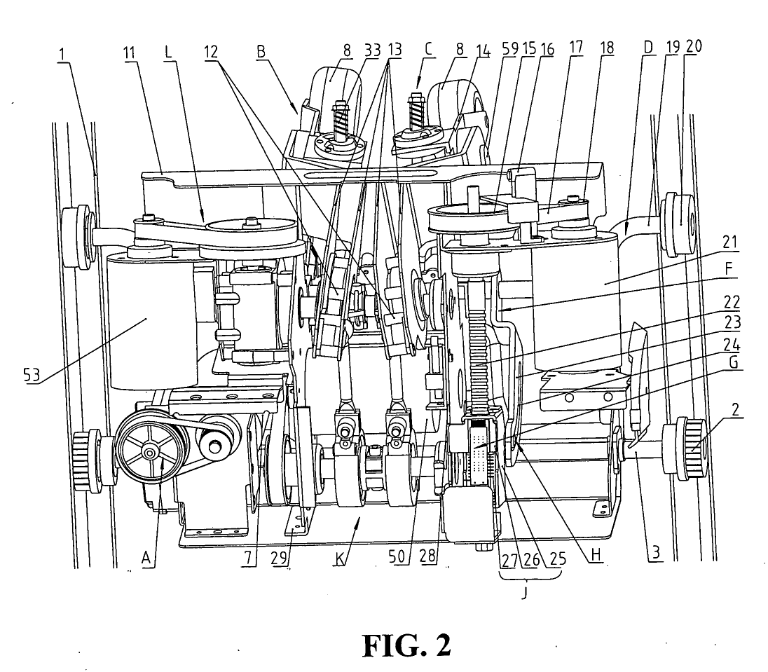

With reference to FIGS. 1 and 2, a massaging mechanism in accordance with the present invention is provided with a backrest 10. The backrest 10 is provided with a pair of parallel guiding rails 1 along both sides. The inside of each of the guiding rails 1 is welded with a rack 4. Both racks are connected with guiding gears 2. A gear shaft 3 is provided between both guiding gears 2. An elevating motor 7 drives a small belt pulley 5 to rotate. The small belt pulley 5 drives an elevating deceleration device A to rotate by an elevating belt 6. The elevating deceleration device A drives the gear shaft 3 to rotate. The elevating deceleration device A comprises a big elevating belt pulley, a worm and a worm gear.

Further, the backrest 10 is provided with a main body plate 11. The main body plate 11 is provided with left and right supporting plates 28, 29. Between the left and right supporting plates 28, 29, a knocking device K, a kneading device L and a massage device B are provided. Also, the outside of the left and right supporting plates 28, 29 are provided with a crank device D, an inclining device F, a detecting device G and a pin-and-sleeve assembly H.

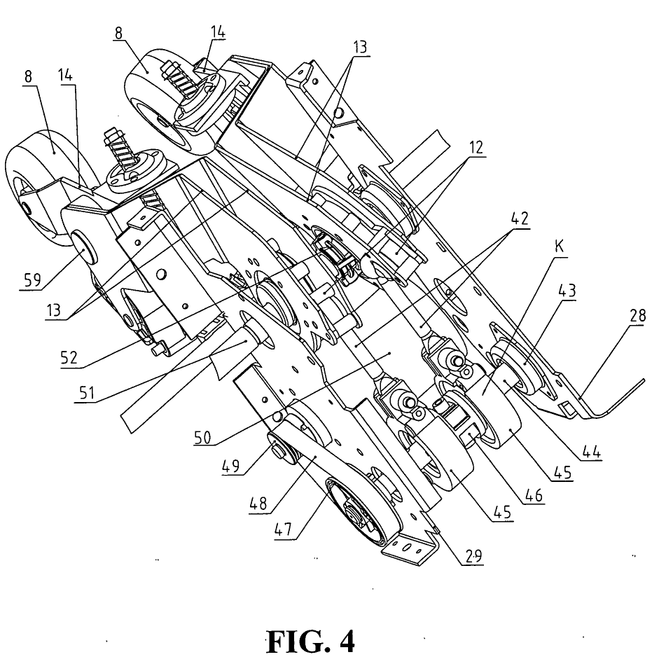

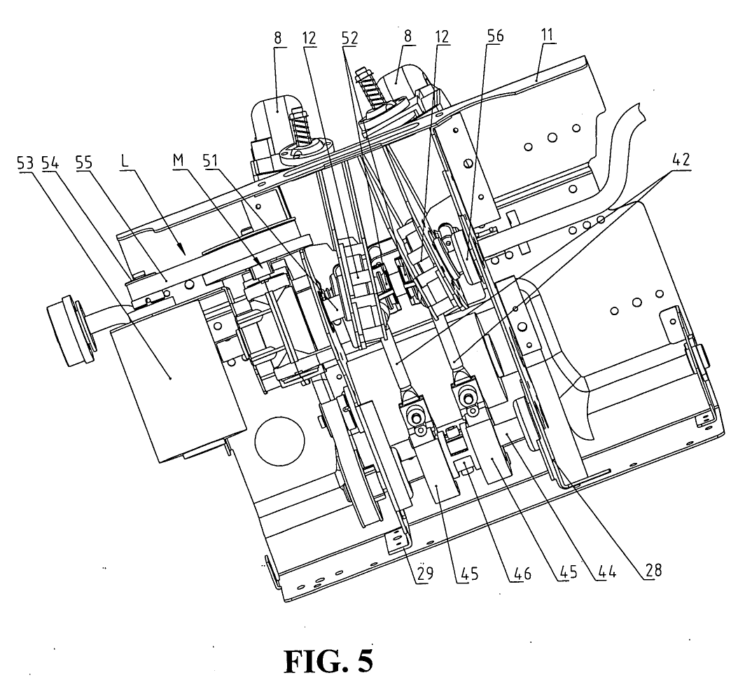

As shown in FIGS. 4 and 5, the knocking device K has corresponding bearing bases 43 fixed to the lower portions of the left and right supporting plates 28, 29. A knocking shaft 44 is arranged between the corresponding bearing bases 43. The knocking shaft 44 is mounted with corresponding knocking supports 45. Each knocking support 45 is connected to a knocking rod 42. The knocking rod is connected to a supporting base 12 of the massage device B.

With reference to FIGS. 2, 4 and 5, a kneading device L has corresponding bearing bases 56 fixed to the upper portions of the left and right supporting plates 28, 29. The left and right supporting plates 28, 29 and the bearing bases 56 support a kneading shaft 51. The kneading shaft 51 between the left and right supporting plates 28 and 29 is provided with kneading selection sleeves 52. The kneading shaft 51 outside the left supporting plate 29 is assembled with a kneading deceleration device M. The kneading deceleration device M comprises a big kneading belt pulley, a worm and a worm gear. A kneading motor 53 is mounted by the kneading deceleration device M. The shaft of the kneading motor 53 is provided with a small kneading belt pulley 54. A kneading belt 55 connects the small kneading belt pulley 54 and the big kneading belt pulley.

As shown in FIGS. 2-5, the massage device B is provided with corresponding supporting bases 12. Each supporting base 12 is fixed with supporting side plates 13. The supporting side plate 13 is connected to a small massaging side plate 31 and a wheel-supporting plate 14 by a side plate pin shaft 59. Further, the small massaging side plate 31 and the wheel-supporting plate 14 are assembled with big and small massaging balls 8, 9 and a universal rotating device C. The universal rotating device C comprises a locking nut 35, a rotating blocking plate 36, a retracting spring 33, a universal rotating sleeve 32, a rotating shaft 34 and a universal rotating ball 39.

When the knocking shaft 44 rotates to drive the supporting side plate 13 to rotate, since the big and small massaging balls 8, 9 fixed on the supporting side plate 13 are hindered by the kneading shaft 51 from rotating 360 degrees, the big and small massaging balls can only produce upward and downward eccentric motions (i.e., knocking actions) around the kneading shaft 51. Therefore, when the knocking shaft 44 rotates, the massage device can perform knocking massage to the person to be massaged.

When the knocking device K and the kneading device L operate at the same time, the massage device can perform knocking massage and kneading massage to the person to be massaged.

The kneading motor 53 drives the small kneading belt pulley 54, and the small kneading belt pulley 54 drives the kneading shaft 51 to rotate via the kneading belt 55 and the kneading deceleration device M. The supporting base 12, which is fixed on the supporting side plate 13 and connected to the knocking device K, cannot rotate. Therefore, the kneading selection sleeves 52 mounted on the kneading shaft 51 can only drive the supporting side plate 13 via the supporting base 12 to move reciprocally in a leftward-and-rightward direction. Accordingly, the big and small massaging balls 8, 9 connected to the supporting side plate 13 can move reciprocally in a leftward-and-rightward direction to perform kneading massage to the person to be massaged.

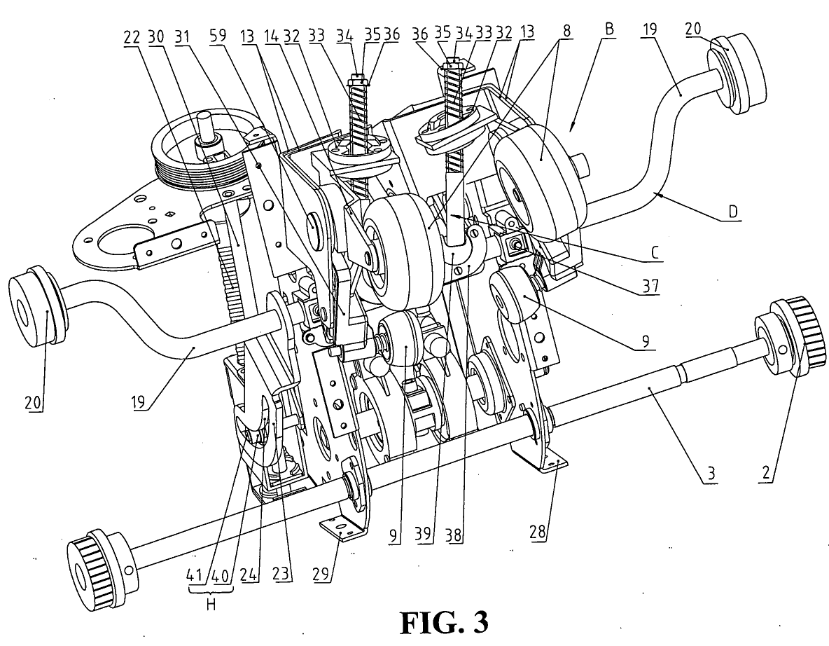

As shown in FIGS. 1 and 3, the crank device D has corresponding crank-fixing frames 37 mounted to the outside of the left and right supporting plate 28, 29. A crank 19 is mounted to the crank-fixing frame 37. Both ends of the crank 19 are assembled with corresponding rollers 20. The rollers 20 are assembled to the racks 4 of the guiding rails 1 at both sides of the backrest 10. Furthermore, the crank 19 is welded with an inclining supporting plate 38 and an inclining driving plate 23. The crank device D is connected to the massage device B by the inclining supporting plate 38, and connected to the inclining device F by the inclining driving plate 23.

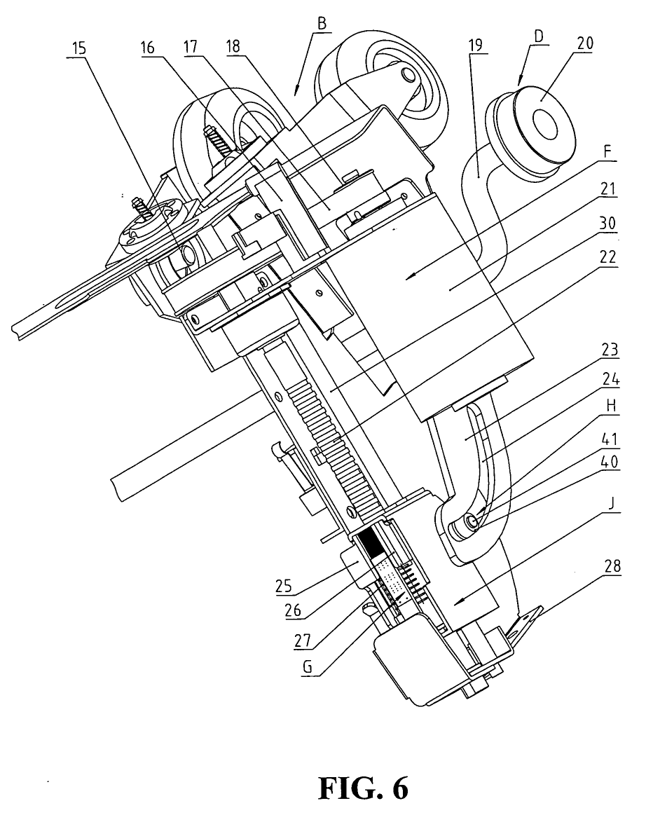

As shown in FIGS. 1, 3 and 6, the inclining device F has an inclining motor 21 mounted outside the left supporting plate 29. The shaft of the inclining motor 21 is provided with a small inclining belt pulley 18. An inclining directing pillar 30 is by the inclining motor 21. One end of the inclining directing pillar 30 is assembled with a big inclining belt pulley 15. An inclining belt 17 connects the small inclining belt pulley 18 and the big inclining belt pulley 15. The inclining belt 17 is provided with a rotation-measuring element 16. An inclining screw 22 is by the inclining directing pillar 30. The lower portion of the inclining screw 22 is provided with an inclining nut assembly J. The inclining nut assembly J has an inclining spring 27 to force an inclining nut 26 tightly against a support 25. The inclining nut 26 is mounted to an inclining screw 22 and the inclining directing pillar 30.

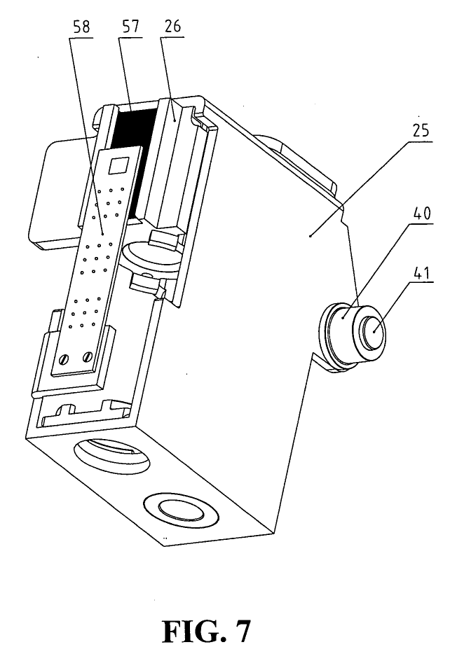

As shown in FIGS. 1, 6 and 7, a detecting device G comprises a detecting magnet 57 mounted on the inclining nut 26 and a Hall sensor 58 mounted on a support 25 with respect to the horizontal plane of the detecting magnet 57. The pin-and-sleeve assembly H includes an inclining pin shaft 41 mounted on the support 25 and a copper sleeve 40 mounted on the inclining pin shaft 41. The copper sleeve 40 can slide in a groove 24 of the inclining driving plate 23.

As shown in FIGS. 1, 6 and 7, when the massaging mechanism of the present invention is in operation, the detecting device G can detect signals from the person to be massaged and send a signal to a main control board (not shown). The main control board issues a command to the elevating motor 7 to drive the gear shaft 3 to move upward or downward. As a result, the big and small massaging balls 8, 9 also move upward or downward and automatically locate the shoulders of the person to be massaged.

As shown in FIGS. 2-5, when the big and small massaging balls 8, 9 arrive the shoulders of the person to be massaged, the main control board commands the inclining motor 21 to drive the inclining nut assembly J to move upward along the inclining screw 22 and the inclining directing pillar 30. The pin-and-sleeve assembly H mounted on the inclining nut assembly J slides in the groove 24 of the inclining driving plate 23, thereby driving the crank device D to rotate. Therefore, the big and small massaging balls 8, 9 of the massage device B are extruded forward with respect to the backrest 10. The distance in which the big and small massaging balls 8, 9 are extruded forward can be detected by the rotation-measuring element 16, so that the big and small massaging balls 8, 9 can exactly arrive the top of the shoulders of the person to be massaged and carry out the massage.

Next, when the inclining device F drives the crank device D, the big and small massaging balls 8, 9 can be trusted out to a certain distance and move upward and downward, a rolling massage and shiatsu are carried out on the person to be massaged.

Further, when the big and small massaging balls 8, 9 carry out the knocking, kneading, and shiatsu to the person to be massaged, the inclining device F can drive the crank device D to rotate, thereby adjusting the massaging pressure applied by the big and small massaging balls 8, 9. Moreover, when the big and small massaging balls 8, 9 are violently hit by the person to be massaged, the big and small massaging balls 8, 9 can automatically retract to a certain distance by the retracting spring 33 of the universal rotating device C to relieve the reaction force applied on the person to be massage.

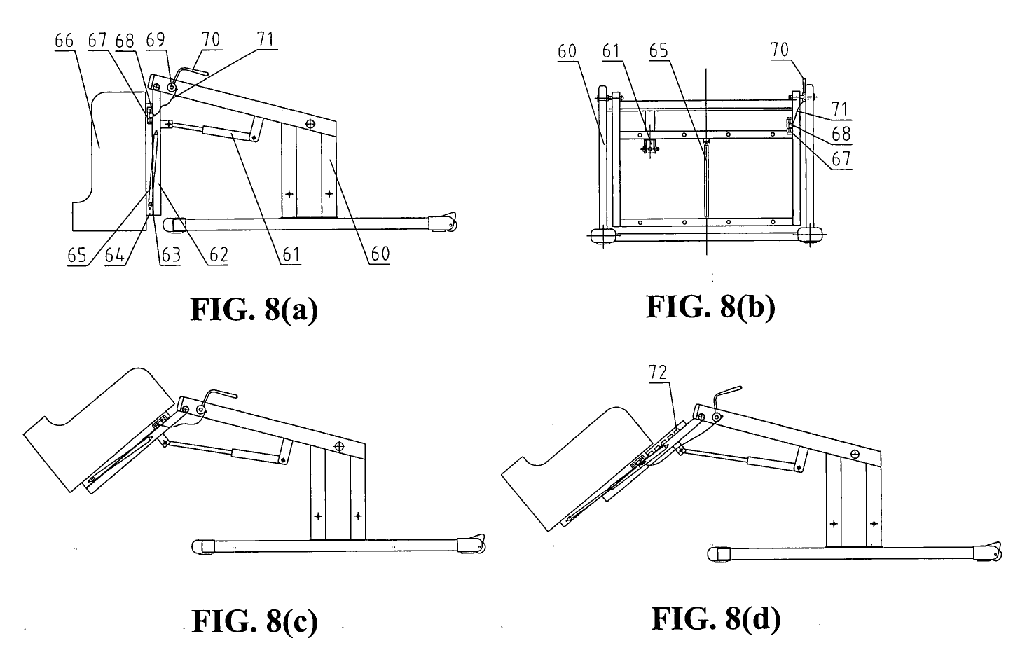

With reference to FIG. 8, the massaging mechanism of the present invention is further provided with a manual footrest elevation device, which allows the user to adjust manually the footrest outward and inward. The manual footrest extension device comprises a footrest framework 60, and a footrest 62 mounted at one end of the footrest frame 60. The upper guiding rail 64 is mounted behind the footrest 62 and a calf-rest 66, which is an M-shape calf-massaging device. A footrest returning spring 67 is provided at one end of the upper guiding rail 64. An air spring 65 connects the footrest 62 and the other end of the upper guiding rail 64. A footrest elevating linkage 61, which is an ascending-and-descending device, connects footrest 62 and footrest framework 60. When there is no external force, the air spring 65 is in a compressed state as shown in FIGS. 8(a) and 8(b). When the footrest 62 is elevated to a certain height by the footrest elevating linkage 61 as shown in FIG. 8(c), the person to be massaged pull a footrest shaft 70 mounted on the footrest framework 60, thereby the footrest pin shaft 69 of the footrest shaft 70 driving a steel wire 71. A footrest block 68 fixed at one end of the steel wire 71 is pulled away from a rail groove 72 of a lower guiding rail 63 by the steel wire 71. When the user's foots push out gently, the calf-rest 66 slides outwards along the lower guiding rail 63 as shown in FIG. 8(d). In the mean time, the air spring 65 is stretched. The user releases the footrest shaft 70 when the calf-rest 66 arrives the appropriate location. As shown in FIG. 8(c), the footrest block 68 is pulled back by the footrest returning spring 67 to a rail groove 72 of the lower guiding rail 63, thereby placing the calf-rest 66 securely. If the person to be massage tries to retract the calf-rest 66, the user pushes the footrest shaft 70, thereby moving the footrest block 68 away the rail groove 72 of the lower guiding rail 63.

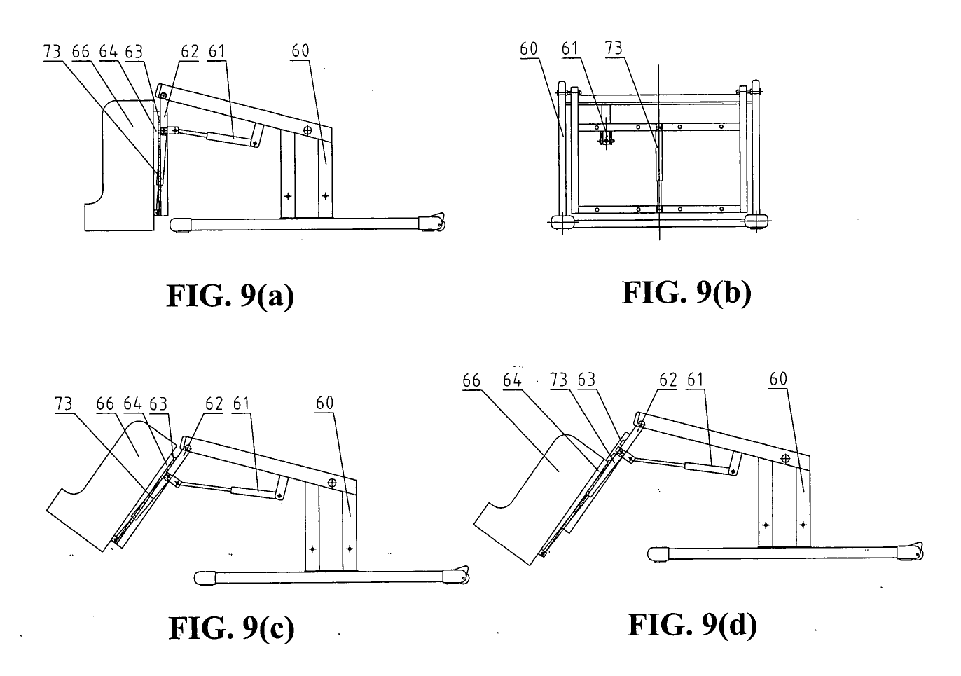

With reference to FIG. 9, the massaging mechanism of the present invention is further provided with an automatic footrest extension device. The automatic footrest extension device comprises a footrest framework 60, and a footrest 62 mounted at one end of the footrest frame 60. A footrest elevating linkage 61, which is an ascending-and-descending device with a motor, connects footrest 62 and footrest framework 60. A lower guiding rail 63 and an upper guiding rail 64 are provided between the footrest 62 and a calf-rest 66. The lower and upper guiding rails 63, 64 are mounted on the footrest 62 and the calf-rest 66 respectively. The upper guiding rail 64 can slide on the lower guiding rail 63. As shown in FIGS. 9(a) and 9(b), a calf-rest extending linkage 73 is mounted between the footrest 62 and the calf-rest 66. When the person to be massaged uses a remote control (not shown) to make the footrest elevating linkage 61 elevate the footrest 62 to a certain height as shown in FIG. 9(c), the user can control the calf-rest extending linkage moving forward and backward to an appropriate location as shown in FIG. 9(d).

Although the present invention has been described with reference to the preferred embodiment thereof, it is apparent to those skilled in the art that a variety of modifications and changes may be made without departing from the scope of the present invention which is intended to be defined by the appended claims.

According to the above, the structure of the present invention indeed achieves the desired functions and objects. Therefore, the present invention is a novel design in structure, which involves novelty, inventive steps and industrial applicability. Further, the structure and characteristics disclosed in the present invention have not been published or put to public use prior to applying for patent, and thus conforms to the requirements for an invention patent.

What is claimed is:

1. A massage chair mechanism, comprising
a backrest provided with a pair of parallel guiding rails on both sides, wherein each guiding rail is assembled with a rack, each of both racks is assembled with a guiding gear, a gear shaft is provided between the guiding gears, the gear shaft is connected to an elevating motor, and the elevating motor is provided with an small elevating belt pulley to connect to an elevating deceleration device via an elevating belt;
a main body plate provided in the backrest with corresponding a left and a right supporting plates;
a knocking device having corresponding bearing bases fixed to the lower portions of the left and right supporting plates, wherein a knocking shaft is arranged between the corresponding bearing bases, the knocking shaft is mounted with corresponding knocking supports, and each knocking support is connected to a knocking rod;
a kneading device having has corresponding bearing bases fixed to the upper portions of the left and right supporting plates, the left and right supporting plates and the bearing bases support a kneading shaft, and the kneading shaft between the left and right supporting plates is provided with kneading selection sleeves;
a kneading deceleration device attached to the kneading shaft on the outside of the left supporting plate, wherein the adjacency of the kneading deceleration device is provided with a kneading motor, the shaft of the kneading motor is provided with a kneading small belt pulley, the kneading small belt pulley and a kneading big belt pulley are assembled with a belt;
a massage device provided with corresponding supporting bases, wherein the supporting base is connected to the knocking rod of the knocking device, the supporting base is provided with supporting side plates for fixing a small massaging side plate and a wheel-supporting plate together, and the small massaging side plate and the supporting wheel plate are assembled with big and small massaging balls and an universal rotating device;
a crank device having corresponding crank fixing frames mounted to the outside of the left and right supporting plates, wherein the crank fixing frames are assembled with a crank, both ends of the crank are assembled with corresponding rollers, the rollers are attached to the racks of the guiding rails on both sides of the backrest, the crank is welded with an inclining supporting plate and an inclining driving plate, the inclining driving plate is formed with a groove, and the inclining supporting plate is connected to the massage device;
an inclining device having an inclining motor mounted to the outside of the left supporting plate, wherein the shaft of the inclining motor is provided with an small inclining belt wheel, the adjacency of the inclining motor is provided with an inclining directing pillar, the front end of the inclining directing pillar is assembled with an big inclining belt pulley, the small inclining belt pulley and the big inclining belt pulley are assembled with an inclining belt, the inclining belt is mounted with a rotation-measuring element, and the adjacency of the inclining directing pillar is provided with an inclining screw;
an inclining nut assembly mounted to the rear portion of the inclining screw of the inclining device, wherein the inclining nut assembly has an inclining spring to force an inclining nut to tightly abut against a support, the inclining nut is attached to an inclining screw and the inclining directing pillar of the inclining device;
a detecting device having a detecting magnet mounted to the inclining nut, wherein a Hall sensor is mounted on the support of the inclining nut assembly with respect to the horizontal plane of the detecting magnet; and
a pin-and-sleeve assembly having a pin shaft and a copper sleeve mounted to the support of the inclining nut assembly, wherein the copper sleeve is positioned in the groove of the inclining driving plate of the crank device.

2. The massage chair mechanism according to claim 1, comprising a manual footrest elevation device, comprising
a footrest framework;
a footrest connected to the footrest framework; and
a calf-rest;
wherein a footrest returning spring is provided between the footrest and one end of the upper guiding rail, which is mounted behind the calf-rest, and an air spring connects the footrest and the other end of the upper guiding rail;
wherein a footrest elevating linkage connects the footrest and the footrest framework; and
wherein a footrest pin shaft of the footrest shaft, which is mounted on the footrest framework, pulls a steel wire and guides the footrest block to a rail groove attached to the steel wire thereon.

3. The massage chair mechanism according to claim 1, comprising an automatic calf-rest extension device, comprising
a footrest framework;
a footrest connected to the footrest framework; and
a calf-rest;
wherein an upper guiding rail mounted on the calf-rest can slide on a lower guiding rail; and
wherein a footrest elevating linkage connected to the footrest and the footrest framework and a calf-rest extension linkage connected to the calf-rest and the footrest can move outward, inward, upward and downward by the remote control.

4. The massage chair mechanism according to claim 1, wherein the elevating deceleration device comprises an elevating big belt pulley, a worm and a worm gear.

5. The massage chair mechanism according to claim 1, wherein the kneading deceleration device comprises a big kneading belt pulley, a worm and a worm gear.

6. The massage chair mechanism according to claim 1, wherein the universal rotating device comprises a locking nut, a rotating blocking plate, a retracting spring, a universal rotating sleeve, a rotating shaft and a universal rotating ball.
